(19) United States
(12) Patent Application Publication
(10) Pub. No.: US 2022/0151280 A1
(43) Pub. Date: May 19, 2022

(54) SEASONING DISPENSING APPARATUS AND METHODS FOR FOOD PROCESS LINE

(71) Applicants: Robert G. Nothum, JR., Willard, MO (US); Ryan D. Nothum, Springfield, MO (US)

(72) Inventors: Robert G. Nothum, JR., Willard, MO (US); Ryan D. Nothum, Springfield, MO (US)

(21) Appl. No.: 16/842,972

(22) Filed: Apr. 8, 2020

Related U.S. Application Data
(63) Continuation of application No. 62/831,280, filed on Apr. 9, 2019.

(51) Int. Cl. A23P 20/12; B05C 11/10; B05C 5/02

(52) U.S. Cl. CPC A23P 20/12; B60P 3/20; B05C 5/0283; B05C 11/1021

(57) ABSTRACT

Apparatus and methods of seasoning food product in a mechanized food product line advantageously seasons the food product in cartons or containers therefor so that the number of days or so of shipment from the process plant to destinations like grocery stores does double duty as time for the seasoning to be absorbed. Food product can be loaded into containers, which are placed on a conveyor line and passed under a seasoning dispenser which thereby applies a top coat. The containers are conveyed to shrink wrap stations or like packaging closure processes, then to refrigerated or freezer storage and onward by refrigerated or freezer motor vehicles. The dispensing apparatus has metering provisions for application of a measured amount and a controller for switching the dispenser ON as a container passes underneath and then OFF as the container goes past.

### CROSS-REFERENCE TO PROVISIONAL APPLICATION(S)

This application claims the benefit of U.S. Provisional Application No. 62/831,280, filed Apr. 9, 2019. The foregoing patent disclosure is incorporated herein by this reference thereto.

### BACKGROUND AND SUMMARY OF THE INVENTION

The invention generally relates to automatic and/or mechanized food-process line equipment and, more particularly, seasoning dispensing apparatus including apparatus for dispensing seasoning blends in metered application amounts.

In the food process industry, there is a little bit of a distinction between seasoning dispensing and coating processes. In some food process lines, for some food products, there typically might be as many as four (4) coating processes:

1—pre-dust;

2—batter;

3—outer coat (eg., Panko crumb);

4—fry; and so on.

The frying process is considered a ‘coating’ process in part because fried food product discharged to downline processes does carry away with it some measure of fry oil. That is, fry oil has to be constantly added to the fryer pool because small measures of fry oil are being constantly carried away by departing food product.

And that aspect of coating processes is true for the other three steps as well. Flour, batter and/or crumb has to be constantly added to the respective coating apparatus because departing food product is always carrying some measure away.

However, coating processes are distinguished from seasoning apparatus in accordance with the invention in that, the respective coating apparatus are always supplied with an excess of the coating material (including fry oil). As long as there is a surplus, the respective coating apparatus works fine. In fact, the flour coating apparatus and the crumb coating apparatus are likely to include tumbling or agitating provisions to shake off excess material, and then a recirculation system for recirculating the shaken off excess back to the input end of the respective coating apparatus.

Seasoning apparatus in accordance with the invention dispenses seasoning in fairly accurately measured amounts. There are no provisions to shake off excess. There is no recirculation system. In fact, in one preferred mode of use of the invention, the seasoning is dispensed directly into the shipping cartons of food product immediately before the cartons are sealed and shipped.

The example shown in the figures here are four (4) whole ready-to-roast chickens disposed inside a plastic-liner lined cardboard carton. The dispensing apparatus in accordance with the invention is configured to dispense the proper amount of seasoning for that weight (or whatever other metric is chosen) of food product (ie., the four whole chickens).

And then the liner and carton are sealed and shipped. In the two to four days before the four whole chickens reach their destination, they essentially marinade themselves in that last step seasoning application. Then the chickens can be roasted, baked, rotisserie grilled or whatever at the user's choice.

A number of additional features and objects will be apparent in connection with the following discussion of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of seasoning dispensing apparatus in accordance with the invention for food process lines;

FIG. 2 is an enlarged-scale perspective view of seasoning dispensing apparatus in FIG. 1;

FIG. 3 is an enlarged-scale perspective view of detail III-III in FIG. 2, wherein a closure panel is shown open;

FIG. 4 is an enlarged-scale section view of taken along line IV-IV shown in FIG. 3;

FIG. 5 is an enlarged-scale perspective view of detail V-V in FIG. 4;

FIGS. 6A through 6D tile together and form a multi-sheet block diagram of a seasoning dispensing method in accordance with the invention, showing a first embodiment of the method wherein one non-exclusive characteristic comprises, by means of an underpassing conveyor, application of a bottom coat in empty shipping cartons followed by the loading of whole birds and a top coat on that before closing the shipping carton;

FIGS. 7A and 7B tile together and form a plural-sheet block diagram of a seasoning dispensing method in accordance with the invention, showing a second embodiment of the method wherein a further embellishment includes transportation of the closed containers with their seasoned contents onboard refrigerated vehicles to remote destinations;

FIGS. 8A and 8B tile together and form a multi-sheet block diagram of a seasoning dispensing method in accordance with the invention, showing a third embodiment of the method wherein one non-exclusive characteristic comprises, by means of an underpassing conveyor, application of a top coat only on bird-loaded shipping cartons;

FIGS. 9A and 9B tile together and form a plural-sheet block diagram of a seasoning dispensing method in accordance with the invention, showing a fourth embodiment of the method wherein one non-exclusive characteristic comprises, by means of an underpassing conveyor, application of both the bottom coat and the top coat like FIG. 6 but with only a single seasoning dispensing apparatus instead of two;

FIG. 10A through 10C tile together and form a multi-sheet block diagram of a seasoning dispensing method in accordance with the invention, showing a fifth embodiment of the method wherein one non-exclusive characteristic comprises, by means of an underpassing conveyor, application of both the bottom coat and top coat with a single seasoning dispensing apparatus like FIGS. 9A and 9B, except including lane diverters, return reverse-flow conveyors and lane mergers for increasing the automatic functions of the process of loading the whole birds;

FIG. 11 is block diagram of a seasoning dispensing method in accordance with the invention, showing a sixth embodiment of the method wherein one non-exclusive characteristic comprises, by means of an underpassing conveyor, application of a top coat on food product pieces pre-loaded into open styrofoam trays which will eventually be sealed in shrink wrap film by wrapping and heat-shrink process(es); and

FIGS. 12A and 12B tile together and form a plural-sheet block diagram of a seasoning dispensing method in accordance with the invention, showing a seventh embodiment of the method wherein one non-exclusive characteristic comprises, by means of an underpassing conveyor, application of a top coat on bare cutlets of food product pieces which later can be stacked or partially-stack into open styrofoam containers and then eventually sealed in shrink wrap film by wrapping and heat-shrink process(es).

### DETAILED DESCRIPTION OF THE PREFERRED EMBODIMENTS

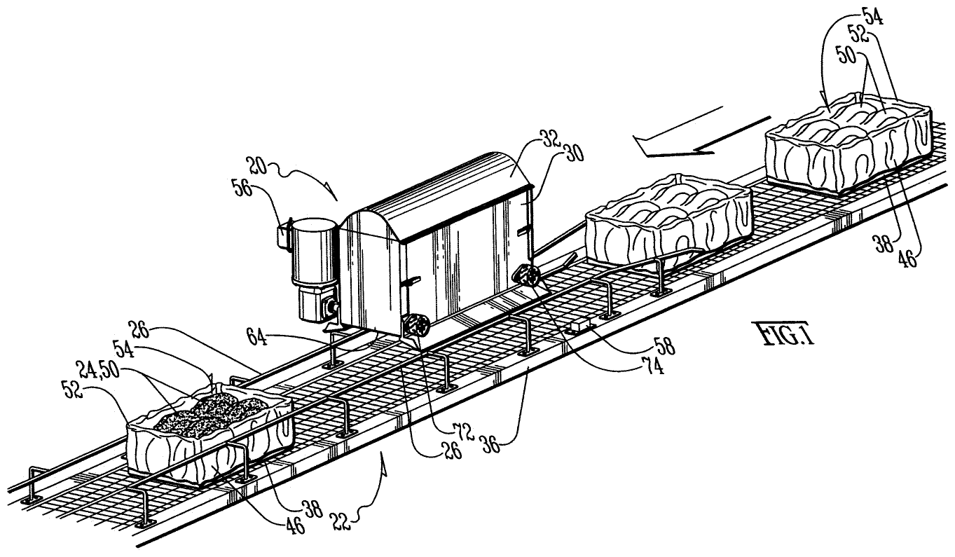

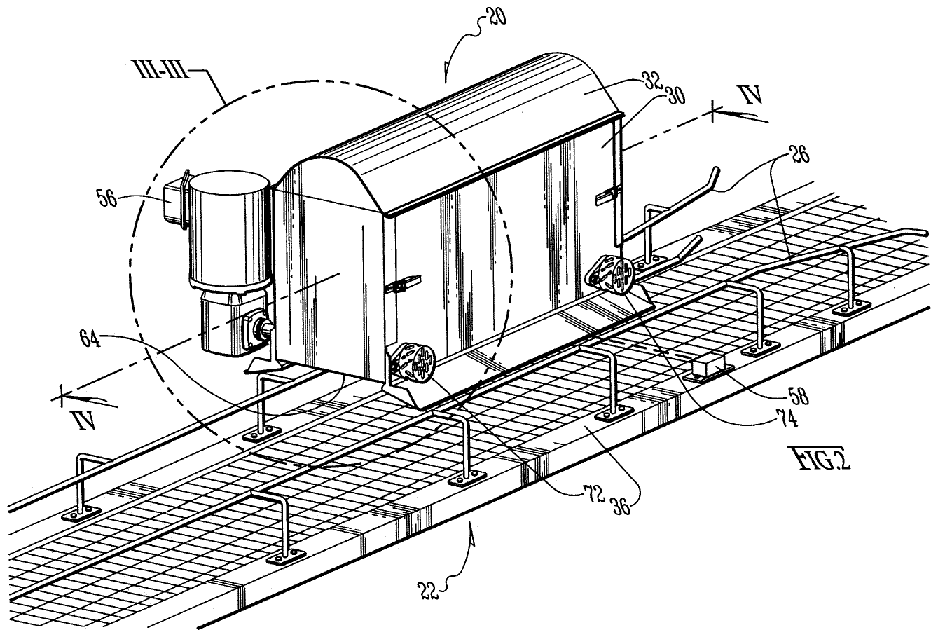

FIGS. 1 through 5 depict seasoning dispensing apparatus 20 in accordance with the invention for automatic and/or mechanized food-process line 22.

Seasoning blend 24 is loaded in the open top of the rim of an open-topped hopper 30. The open top is shut by a lid 32 pivoted on side-mounted hinges. The hopper 30 is suspended above the elevation of an under-flowing conveyor 36 under which a queue (or series) of opened-up cardboard cartons 38 (or containers) flow underneath. The cartons 38 are opened up in the manner of having four closure flaps 42 folded out and down to lay alongside a respective on of the four sidewalls 44 on the outside thereof. The cardboard cartons 38 are preferably lined with a plastic liner 46. The cardboard cartons 38 will be ultimately loaded with a food product payload 50. For sake of an example, the cartons 38 might be loaded with an integer number “N” of whole uncooked rotisserie chickens 50 (eg., “N” equals four for example).

The plastic liners 46 are disposed lining the inside of the sidewalls 44 of the cartons 38 with the upper excesses 52 of the liner 46 draping down and encircling the outside of the four closure flaps 42 of the carton 38, not only providing an open cavity 54 to receive the birds 50 (eg., the food product payload 50) and the seasonings 24 (eg., and/or other additives) but also providing retention of the closure flaps 42 and hence keep them out of interference with things.

It is an object of the invention to dispense a metered amount of seasoning 24 into each carton 38. At the end of the seasoning process, the upper excess portions 52 of the liner 46 would be folded back inside the carton 38, and preferably sealed. The carton 38 would then be closed and shipped (under refrigeration the whole way) to a destination where the chickens 50 would be rotisserie cooked, and then sold and/or served.

The seasoning apparatus 20 in accordance with the invention preferably dispenses seasoning 24 by switching, literally, between ON and OFF as open-top cartons 38 pass underneath. Automatic control over the timing of the switching between ON and OFF is enabled by a controller 56 and carton position sensing (eg., 58). An example manner of position sensing includes without limitation an optical sensor 58.

An example optical sensor 58 comprises a light beam source 62 and a sensor 58. The light beam is aimed across the conveyor 36 such that when a carton 38 passes between the source and sensor 58, the sensor 58 senses when the carton 38 breaks the light beam. The detection of this event is inputted to the controller 56, and it times the sequence of later events from that time.

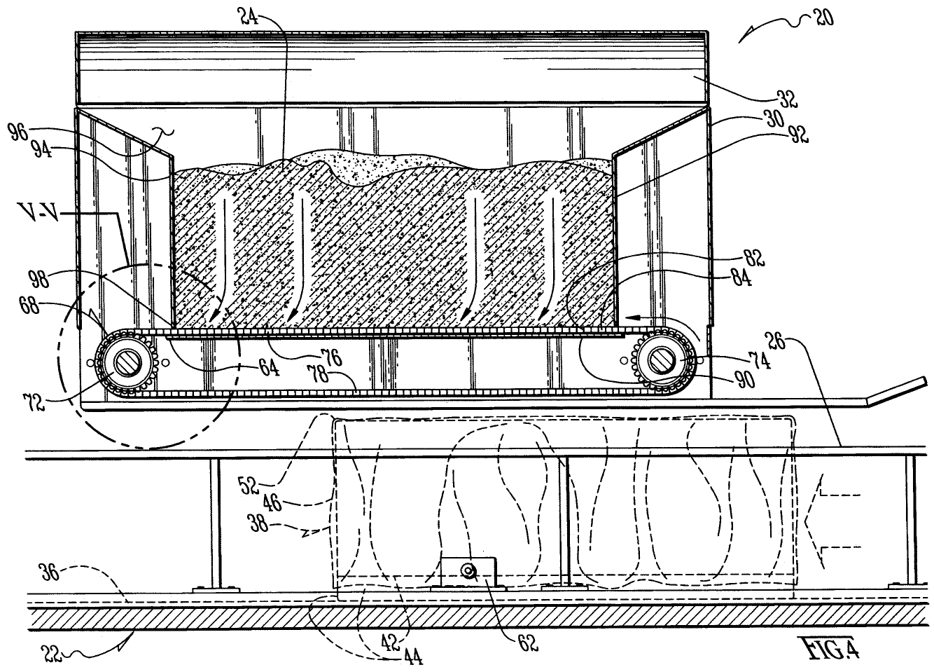

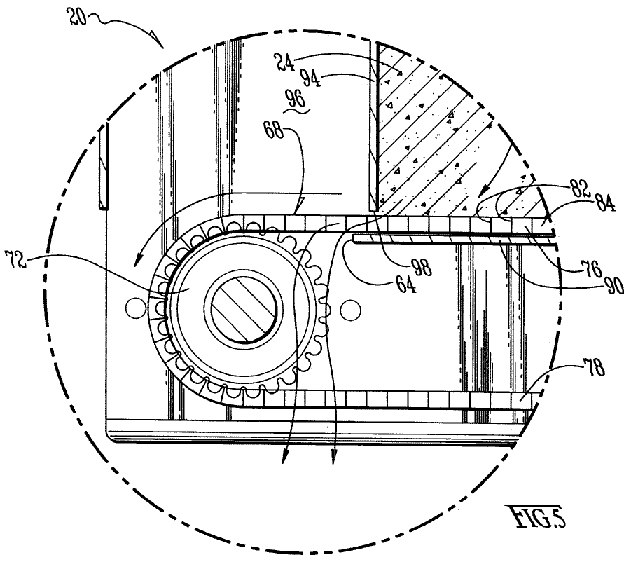

FIGS. 4 and 5 show that the dispensing process in accordance with the invention takes place from the trailing end (edge 64) of the hopper 30, relative to the longitudinal direction of conveyance of the conveyor 36. That is, the downstream end of the hopper 30 is the trailing end, in contrast to the upstream end. Again, FIG. 5 shows that the dispensing of the seasoning mix 24 is taking place underneath the trailing end (edge 64) of the hopper 30.

The dispensing apparatus 20 comprises a hopper 30 and a feed belt 68. As mentioned previously, the seasoning apparatus 20 in accordance with the invention operates by switching, literally, between ON and OFF. In the OFF state, the feed belt 68 is at rest and no seasoning mix 24 is dispensed. In the ON state, the feed belt 68 runs in the direction as indicated in FIG. 5 and seasoning mix 24 is indeed dispensed.

The feed belt 68 comprises an endless wire mesh belt 68 or the like, including without limitation a drag link belt, that runs between a drive roller 72 and an idler roller 74. The feed belt 68 has an upper, particulate carrying run 76 and a lower, return run 78. The belt 68 forms an array of rows 82 and columns 84 of individual cells 82×84 (or pockets). The rows 82 run laterally between left to right extremes 86 and 88, and the columns 84 extend axially with the web of the belt 68. Preferably each row 82 has twenty to twenty-five cells 82×84 or so across from the left edge 86 to the right edge 88. The carrying run 76 of the belt 68 runs on top of a horizontal scrape plate 90 that serves as the bottom wall 90 of the hopper 30. The hopper 30 furthermore has a front wall 92 (eg., in the upstream or upline direction) and a back wall 94. The hopper 30 further has spaced sidewalls 96. The carrying run 76 of the belt 68 runs inside the hopper 30 between the front wall 92 and back wall 94. Both the back wall 94 and front wall 92 have a horizontally-extending slot-like aperture 98×64 to allow the upper, carrying run 76 of the belt 68 travel in and travel out of the hopper 30 proper. These apertures 98×64 present a low eave 98 to allow the carrying run 76 of the belt 68 to just barely pass under. The return run 78 of the belt 68 runs outside of the hopper 30, just underneath the bottom wall 90 (eg., scrape plate 90) of the hopper 30.

FIG. 5 shows the dispensing apparatus 20 in the ON state, and the feed belt 68 is traveling. The cells 82×84 of the lead row 82 of the feed belt 68 are emptying their load of seasoning mix 24 in unison over the trailing edge 64 of the scrape plate 90 into the carton 38 below. The volumetric dispensing rate is equal to (1) the collective volume of seasoning 24 contained in the cells 82×84 in the lead row 82 multiplied by (2) the rate time the cells 82×84 in the lead row 82 empty themselves. Once the cells 82×84 in the lead row 82 have been emptied, a successive lead row 82 follows, and so on in waves of succeeding rows 82, until the belt 68 is stopped. Then the dispensing apparatus 20 is in the OFF state, and dispensing is stopped. It is a design choice to make operation of the dispensing apparatus 20 operated between an ON state where the feed belt 68 runs and an OFF state where the feed belt 68 is stopped. Otherwise, the feed belt 68 would uselessly dump seasoning 24 out over the floor of the clean room.

FIG. 5 shows better that the low eave of the rear wall 94 of the hopper 30 acts to skim excess seasoning 24 level with the elevation of the low eave 98, which is more or less level with the top elevation of the belt 68. That way, there is a uniform volume of seasoning 24 contained in each row 82.

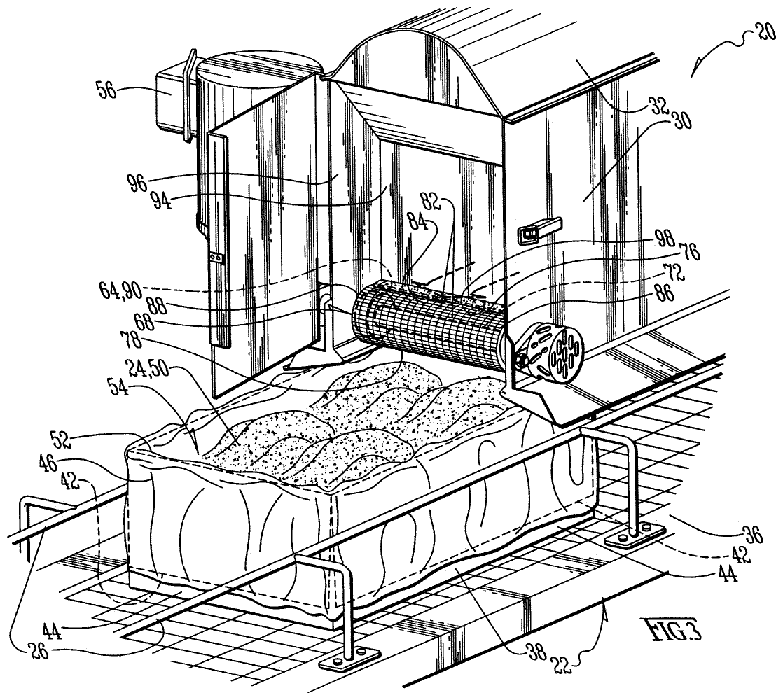

FIGS. 1 through 4 show that the feed belt 68 is stopped (or in FIG. 3, the feed belt 68 has just recently stopped). In FIG. 3, the four roasters 50 are coated. During the transit over several days to their destinations, those seasonings 24 will be absorbed by the whole chickens 50, like a marinade.

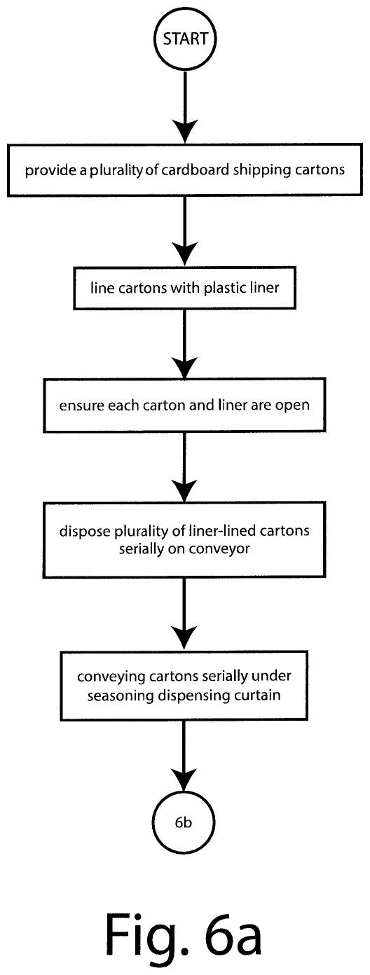

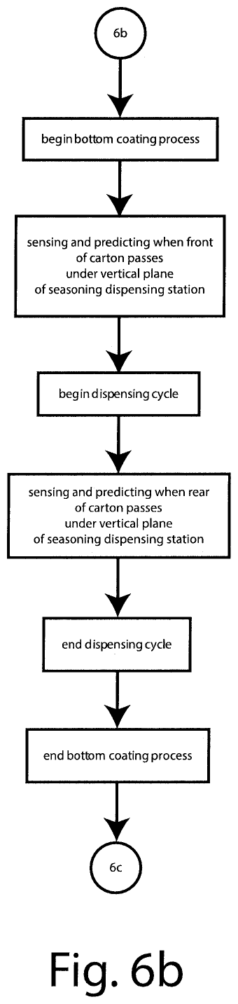

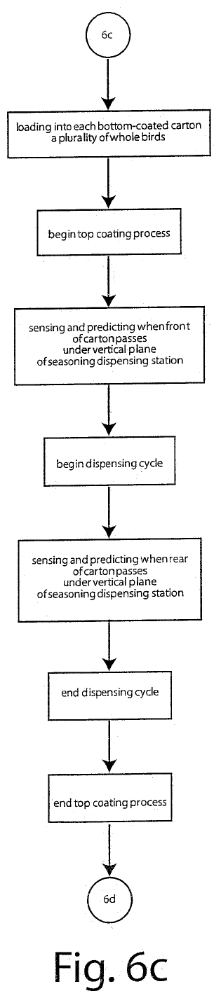

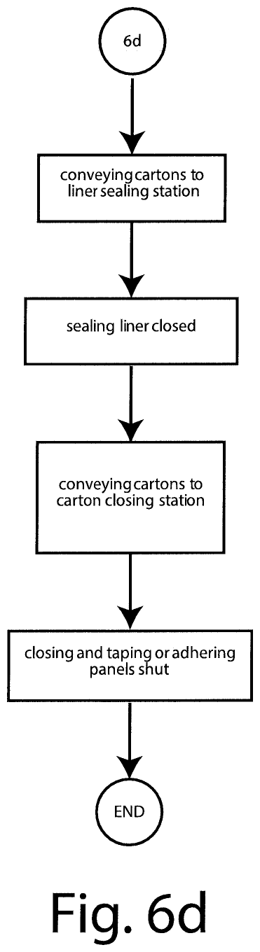

FIGS. 6A through 12B are block diagram depictions of various methods for carrying out the invention. That is, FIGS. 6A through 12B discloses seven respective embodiments of a method in accordance with the invention.

FIGS. 6A through 6D show a first embodiment of a method in accordance with the invention, wherein one non-exclusive characteristic comprises, by means of an underpassing conveyor, application of a bottom coat in empty shipping cartons followed by the loading of whole birds onto the bottom coat then pass again under another seasoning dispensing device and apply a top coat on that before closing the shipping carton.

That is, FIGS. 6A through 6D recite:
provide a plurality of cardboard shipping cartons,
line cartons with plastic liner,
ensure each carton and liner are open,
dispose plurality of liner-lined cartons serially on a conveyor,
convey cartons serially under seasoning dispensing curtain,
begin a bottom coating process,
sense and predict when front of carton passes under vertical plane of seasoning dispensing station (ie., the curtain produced thereby),
begin dispensing cycle by a seasoning dispensing curtain,
sense and/or predict when rear of carton passes past the vertical plane of the seasoning dispensing station,
end dispensing cycle,
thus ends the bottom coating process,
load into each bottom-coated carton a plurality of whole birds,
begin a top coating process,
sense and predict when front of carton passes under vertical plane of seasoning dispensing station (ie., the curtain produced thereby),
begin dispensing cycle by a seasoning dispensing curtain,
sense and/or predict when rear of carton passes past the vertical plane of the seasoning dispensing station,
end dispensing cycle,
and thus ends the top coating process,
continue conveyance of the cartons to a liner sealing station,
seal the liner closed,
continue conveyance of the cartons to a carton closing station, and
close and tape, adhere or staple the flap panels shut.

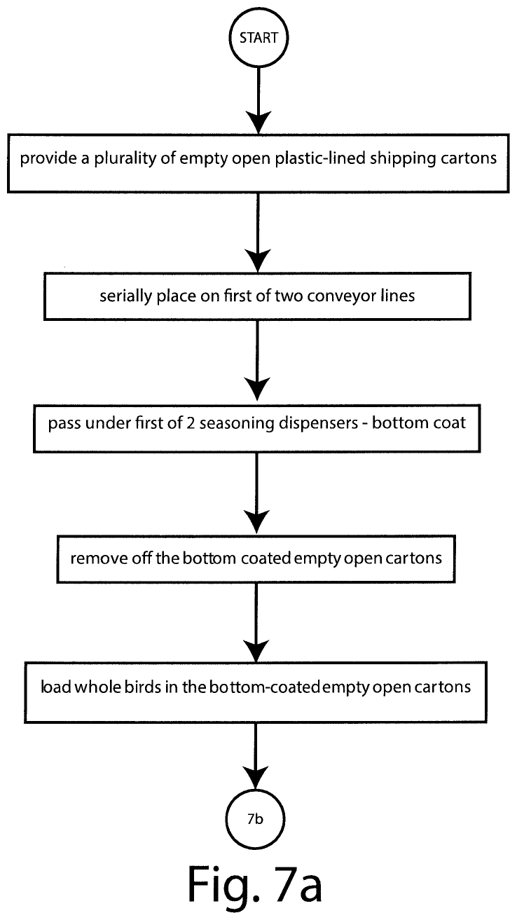

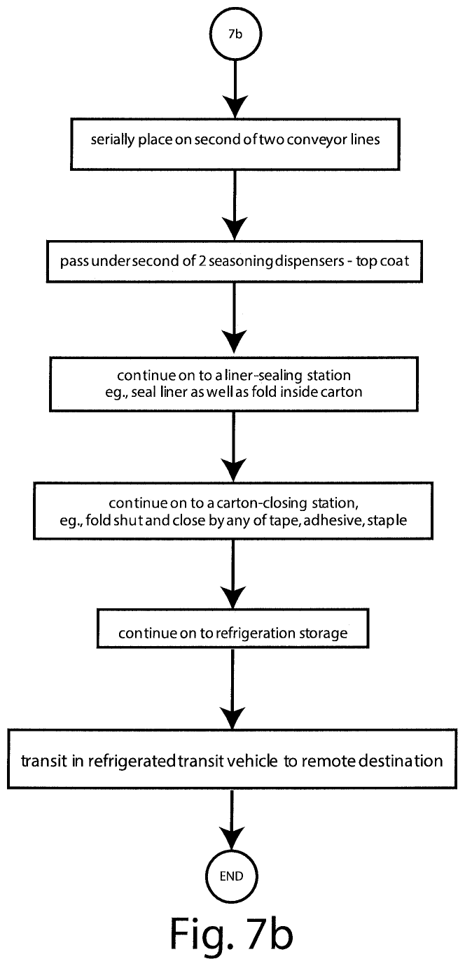

FIGS. 7A and 7B show a second embodiment of a method in accordance with the invention, wherein a further embellishment includes transportation of the closed containers with their seasoned contents onboard refrigerated vehicles to remote destinations. That is, FIGS. 7A and 7B recite:
provide a plurality of empty open plastic-lined shipping cartons,
serially place on a first of two conveyor lines,
pass under a first of two seasoning dispensers—bottom coat,
remove off the first conveyor the bottom coated empty open cartons,
load whole birds in the bottom-coated empty open cartons,
serially place on a second of the two conveyor lines,
pass under a second of the two seasoning dispensers—top coat,
continue on to a liner-sealing station (eg., seal liner as well as fold inside carton),
continue on to a carton-closing station, (eg., fold shut and close by any of tape, adhesive or staple)
continue on to refrigeration storage, and
transit in refrigerated transit vehicle to a remote destination.

The examples above were four whole chickens which might be cooked and displayed in glass-door rotisserie ovens in grocery stores. During storage and transit, the birds are marinading in (absorbing) the seasoning mix. That way, the birds will be pre-seasoned for grocery store, relieving grocery store workers of doing that job. In addition, the birds will marinate much longer before cooking, ideally providing an enhanced, more flavorful effect.

Other non-exclusive remote destinations could be restaurants, smorgasbords, banquet halls and various sorts of hospitality or food service enterprises. Grocery stores can make the uncooked birds available to consumers too. Other examples of food product other than birds includes beef, pork, fish and so on.

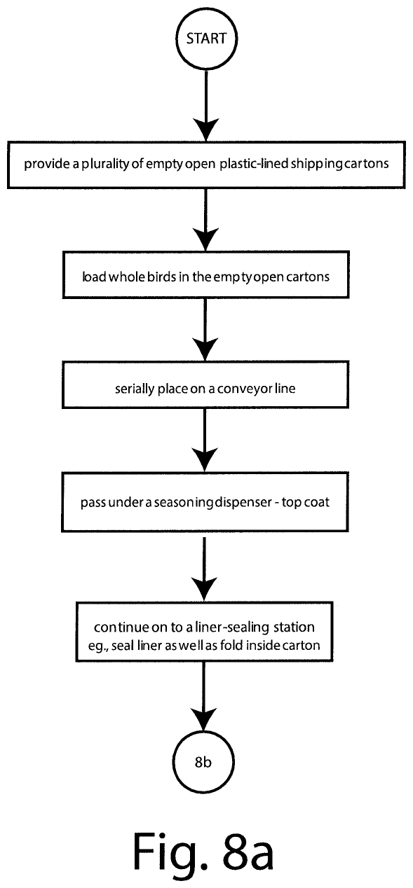

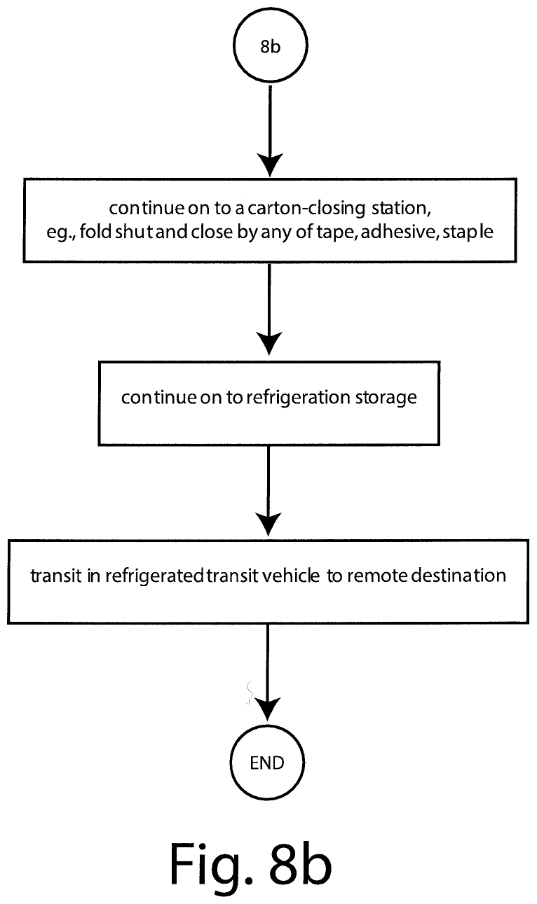

FIGS. 8A and 8B show a third embodiment of a method in accordance with the invention, wherein one non-exclusive characteristic comprises, by means of an underpassing conveyor, application of a top coat only on bird-loaded shipping cartons.

That is, FIGS. 8A and 8B recite:
provide a plurality of empty open plastic-lined shipping cartons
load whole birds (or other food product) in the empty open cartons,
serially place on a conveyor line
pass under a seasoning dispenser—top coat
continue on to a liner-sealing station (eg., seal liner as well as fold inside carton),
continue on to a carton-closing station, (eg., fold shut and close by any of tape, adhesive or staple),
continue on to refrigeration storage, and
transit in refrigerated transit vehicle to remote destination.

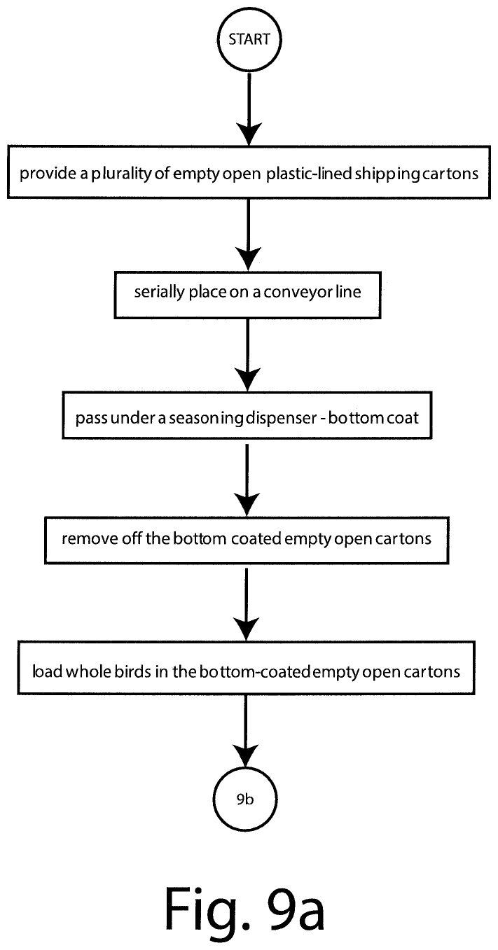

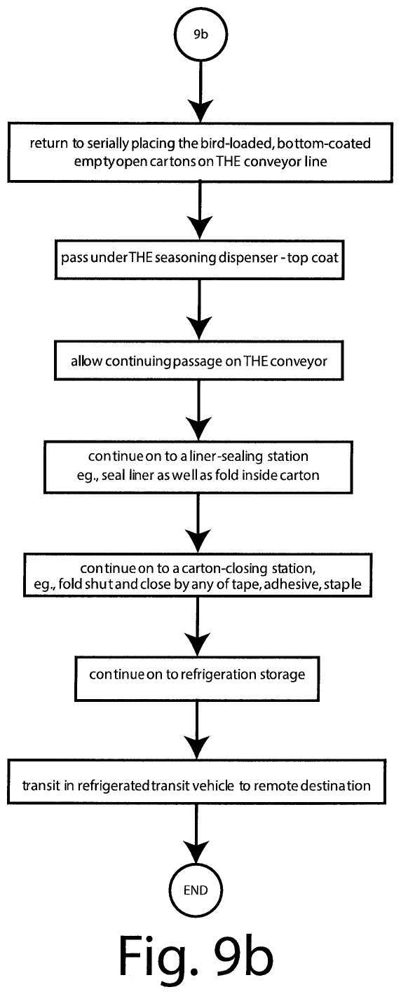

FIGS. 9A and 9B show a fourth embodiment of a method in accordance with the invention, wherein one non-exclusive characteristic comprises, by means of an underpassing conveyor, application of both the bottom coat and the top coat like FIG. 6 but with only a single seasoning dispensing apparatus instead of two. That is, FIGS. 9A and 9B recite:
provide a plurality of empty open plastic-lined shipping cartons,
serially place on a conveyor line,
pass under a seasoning dispenser—bottom coat,
remove off the conveyor the bottom coated empty open cartons,
load whole birds (or other food product) in the bottom-coated empty open cartons,
return to serially placing the bird-loaded, bottom-coated empty open cartons on the conveyor line upline from the seasoning dispenser,
pass under the seasoning dispenser—top coat
allow continuing passage on the conveyor,
continue on to a liner-sealing station (eg., seal liner as well as fold inside carton),
continue on to a carton-closing station (eg., fold shut and close by any of tape, adhesive or staple)
continue on to refrigeration storage, and
transit in refrigerated transit vehicle to remote destination.

The steps of removing off the conveyor and loading food product into the bottom coated empty cartons might be done manually.

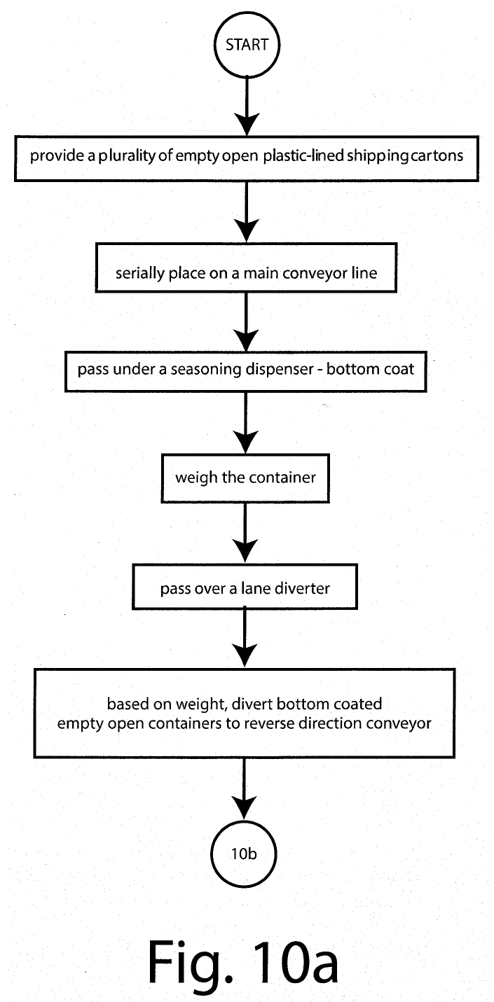

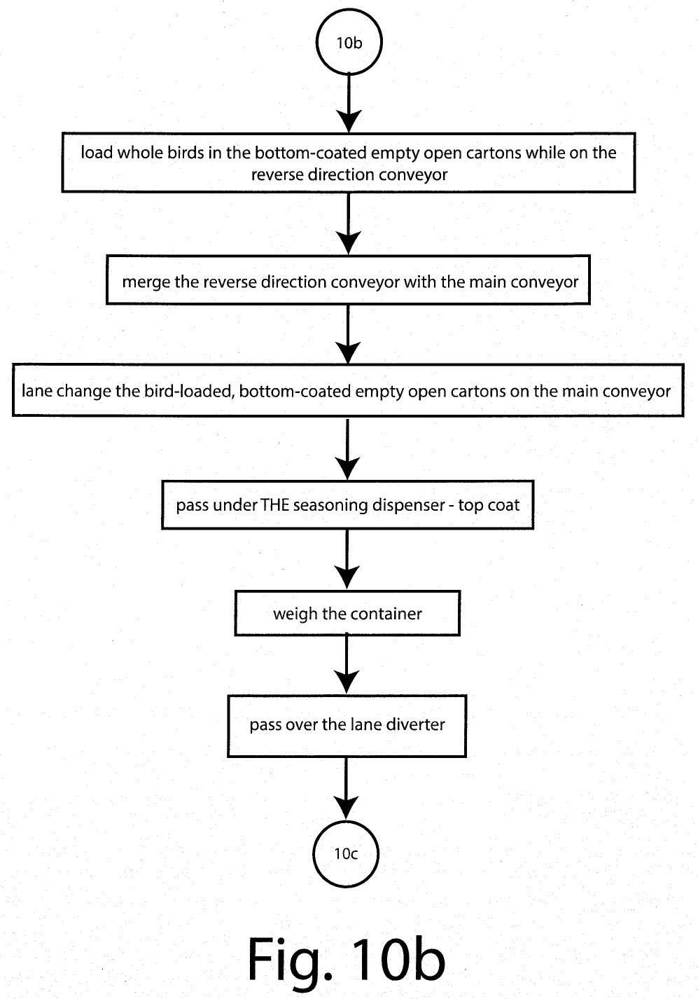

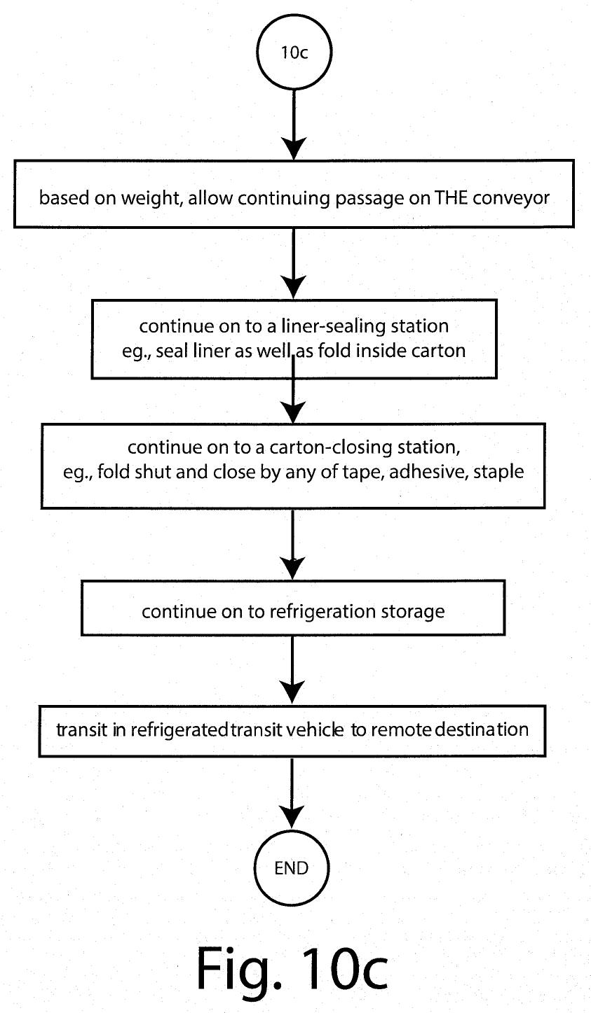

FIG. 10A through 10C show a fifth embodiment of a method in accordance with the invention, wherein one non-exclusive characteristic comprises, by means of an underpassing conveyor, application of both the bottom coat and top coat with a single seasoning dispensing apparatus like FIGS. 9A and 9B, except including lane diverters, return reverse-flow conveyors and lane mergers for increasing the automatic functions of the process of loading the whole birds. That is, FIGS. 10A through 10C recite:
provide a plurality of empty open plastic-lined shipping cartons,
serially place on a main conveyor line,
pass under a seasoning dispenser—bottom coat
weigh the container,
pass over a lane diverter,
based on weight, divert bottom coated empty open cartons to reverse direction conveyor,
load whole birds (or other food product) in the bottom-coated empty open cartons while on the reverse direction conveyor,
merge the bird-loaded bottom coated shipping cartons on the reverse direction conveyor with the main conveyor (that is, upline from the seasoning dispenser, and without colliding with empty open shipping cartons),
lane change the bird-loaded, bottom-coated empty open cartons onto the main conveyor (again, upline from the seasoning dispenser),
pass under the same (single) seasoning dispenser—top coat,
weigh the container,
pass over the lane diverter,
based on weight, allow continuing passage on the main conveyor,
continue on to a liner-sealing station (eg., seal liner as well as fold inside carton),
continue on to a carton-closing station (eg., fold shut and close by any of tape, adhesive or staple),
continue on to refrigeration storage, and
transit in refrigerated transit vehicle to remote destination.

The reverse direction conveyor might be C-shaped such that it takes cartons off the main conveyor downline from the seasoning dispenser at a shallow (acute) angle, loops the cartons back around to a point upline of the seasoning dispenser, and then merges the cartons back onto the main conveyor again at a shallow (acute) angle.

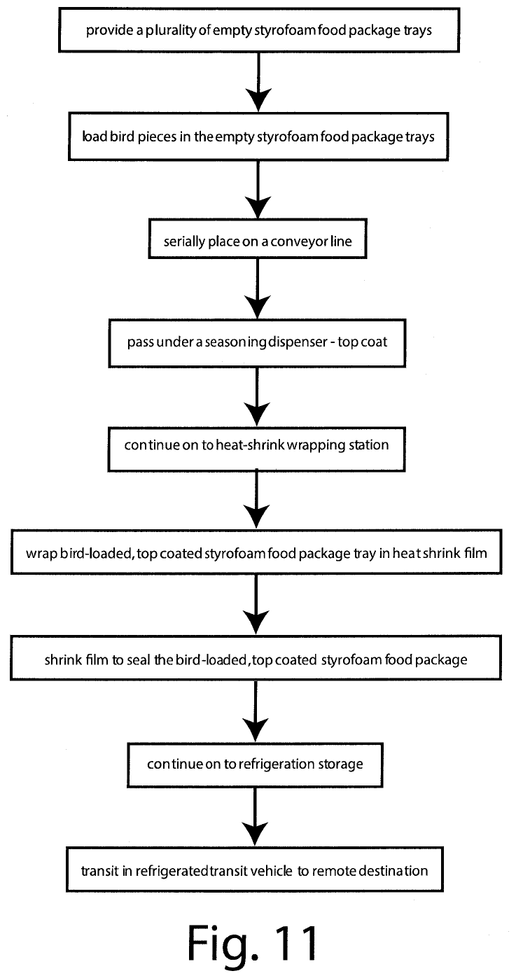

FIG. 11 shows a sixth embodiment of a method in accordance with the invention, wherein one non-exclusive characteristic comprises, by means of an underpassing conveyor, application of a top coat on food product pieces pre-loaded into open styrofoam trays which will eventually be sealed in shrink wrap film by wrapping and heat-shrink process(es). That is, FIG. 11 recites:
provide a plurality of empty styrofoam food package trays,
load bird pieces (any food product) in the empty styrofoam food package trays,
serially place on a conveyor line
pass under a seasoning dispenser—top coat
continue on to heat-shrink wrapping station
wrap bird-loaded, top coated styrofoam food package tray in heat shrink film,
shrink film to seal the bird-loaded, top coated styrofoam food package,
continue on to refrigeration storage (perhaps freezer), and
transit in refrigerated (or freezer) transit vehicle to remote destination.

This method (and/or process line configuration) works better for packaging food product in consumer-sized packaging for sale in grocery stores, including for example eight-packs of chicken breasts, or batches of wings and thighs or the like. These can be sold frozen or thawed. The season mix has some time before freezing to be absorbed by (or marinade) the food product, and some more time while thawing/after thawing.

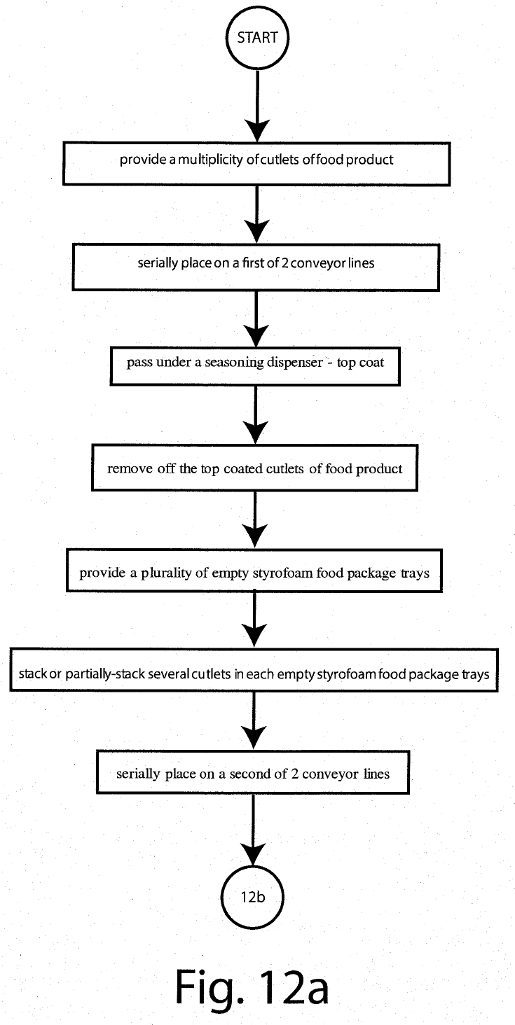

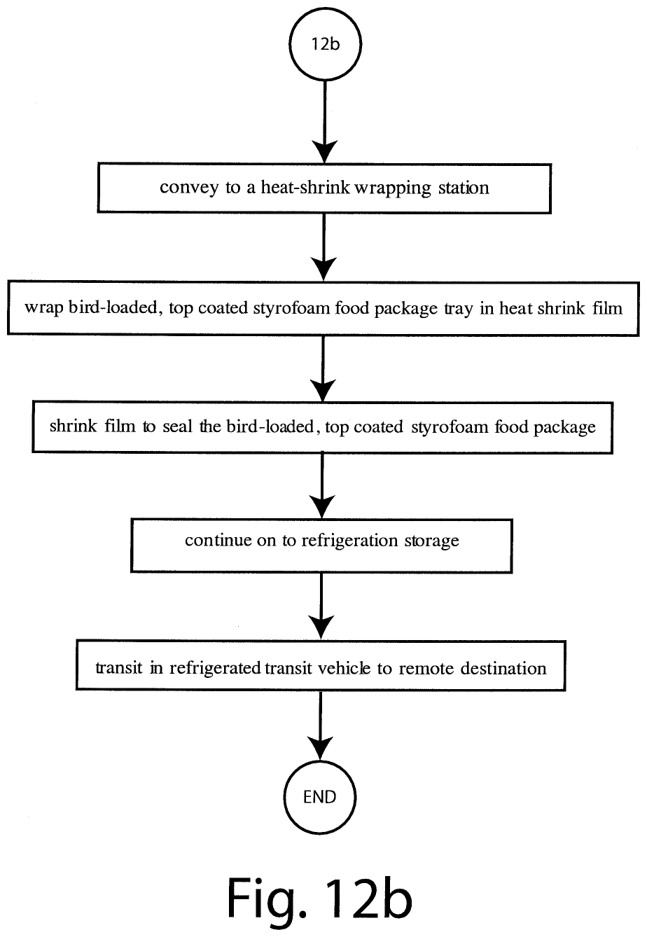

FIGS. 12A and 12B show a seventh embodiment of a method in accordance with the invention, wherein one non-exclusive characteristic comprises, by means of an underpassing conveyor, application of a top coat on bare cutlets of food product pieces which later can be stacked or partially-stack into open styrofoam containers and then eventually sealed in shrink wrap film by wrapping and heat-shrink process(es). That is, FIGS. 12A and 12B recite:
provide a multiplicity of cutlets of food product,
serially place on a first of two conveyor lines,
pass under a seasoning dispenser—top coat,
remove off the top coated cutlets of food product,
provide a plurality of empty styrofoam food package trays,
stack or partially-stack several cutlets in each empty styrofoam food package tray,
serially place on a second of two conveyor lines,
convey to a heat-shrink wrapping station,
wrap cutlet-loaded, top coated styrofoam food package tray in heat shrink film,
shrink film to seal the cutlet-loaded, top coated styrofoam food package
continue on to refrigeration (or freezer) storage, and
transit in a refrigerated (or freezer) transit vehicle to remote destination.
   This method (and/or process line configuration) also works better for packaging food product in consumer-sized packaging for sale in grocery stores, including for example pork steaks, ribs, roasts, and just on and on.

What typifies these kinds of food product is that they are stacked or at least partially stacked upon one another when packaged. Hence top coating the food product in their open packaging containers does little more than reach the topmost member of the stack. To really get the season mix applied to all the members of the stack is better achieved by running the bare product under the seasoning mix before stacking.

It is an aspect of the invention to account for the following factors in the proportions and control over the seasoning apparatus 20 and methods in accordance with the invention.

In the embodiment with plastic-liner 46 lined, open-topped shipping cartons 38, presumptively the plurality of cartons 38 are rectangular. The design factors are made easier if the cartons 38 have a uniform size defining an open cavity 54 bounded by long sides (44) defining a length for the cavity 54, spacing short sides (44) defining a narrower width for the cavity 54 and which collectively define a height for the carton 38 (which height for the carton 38 is going to be more or less the height for the cavity 54 too). Assume the cartons 38 are conveyed on the conveyor 36 with one short side leading.

It is assumed that the seasoning 24 is a mostly dry particulate. The dispenser 20 dispenses the seasoning 24 by the work of the feed belt 68 urging the seasoning 24 over the trailing edge 64 of the scrape plate 90, past which the dry particulate 24 falls in a curtain-like shower. Design factors are made furthermore easier if the trailing edge 64 of the scrape plate 90 is straight and runs perpendicular to the path (ie., 36) of the underpassing cartons 38. That curtain-like shower of dispensed seasoning 24 defines a given axial plane or station that is reckoned as the dispensing station. The given axial plane or station can be reckoned as a vertical plane, but the curtain-like shower of dispensed seasoning 24 is a cascade following a parabolic trajectory. In practice, at the preferred run speeds for the feed belt 68, curtain-like shower of dispensed seasoning 24 straightens out not to far below the elevation of the feed belt 68 and is more or less vertical below that.

The conveyor 36 can have a width greater or narrower than the width of the cartons 38. But it is preferred if the width of the curtain-like shower of the dispensed seasoning 24 corresponds very closely to the width of the opening into the cavity 54 of the carton 38. This can be achieved by the design of the hopper 30 where the lateral (eg., left and right) sidewalls 96 are more or less parallel and have a width that corresponds very closely to the width of the opening into the cavity 54 of the carton 38. Likewise, the feed belt 68 preferably has spaced parallel side edges 86 and 88 which give the feed belt 68 a uniform width that also corresponds very closely to the width of the opening into the cavity 54 of the carton 38.

Again, the width of the conveyor 36 that passes through the given axial station defined by curtain-like shower of dispensed seasoning 24 does not need to correspond closely to the width of the opening into the cavity 54 of the carton 38. Indeed, preferably the conveyor 36 width is a little wider. As the cartons 38 travel down the conveyor 36 and approach the seasoning dispenser 20, the cartons might likely be a little askew. But the lane the cartons 38 travel though as the cartons 38 pass under the seasoning dispenser 20—an particularly though the given axial station defined by the curtain-like shower of dispensed seasoning 24—the left to right position of the cartons is trued by rub rails 26 or the like. FIG. 1 shows utilization of stainless steel siderails 26 that rub the carton 38 (actually, the upper excess portions 52 of the liner 46) at about halfway up the height of the carton 38. The side rails 26 align (line up) the breadth of the width of the opening into the cavity 54 of the container 38 with the breadth of the width of the curtain-like shower of dispensed seasoning 24.

Given things straight and true as described or suggested above, the amount of seasoning 24 actually dispensed is determinable and in part controlled by the following.

The main conveyor 36 runs at a speed, preferably a uniform speed. That speed offers an opportunity for adjustment. However, the feed belt 68 also runs at a speed, and preferably a more or less uniform speed between very quick starts and very sudden stops. The speed of the feed belt 68 also offers an opportunity for adjustment. The rate at which seasoning 24 pours over the trailing edge 64 of the scrape plate 90 is a function of the volumetric carrying capacity of all the cells 82×84 in a given row 82, in proportion to an axial length of the row 82 between a leading edge and trailing edge, and in furthermore proportion to the speed of the feed belt 68. The volumetric carrying capacity of all the cells 82×84 in a given row 82 is proportional to the width of the feed belt 68, in proportion to the gap height 98×96 of the low eave 98 that the trailing sidewall 94 of the dispenser hopper 30 defines over the plane of the scrape plate 90.

Hence a volumetric flowrate for the curtain-like shower of dispensed seasoning 24 is knowable. It might be calculated. Or it might just be calibrated. The feed belt 68 can be sped up or slowed down until a chosen flowrate is achieved. The quantity of seasoning 24 dispensed in any carton 38 is proportionate to the volumetric flowrate for the curtain-like shower of dispensed seasoning 24 relative to the speed of the main conveyor 36:—that is, the length of time it takes for the length of the cavity 54 to pass through (and collect) the seasoning 24 of the curtain-like shower of dispensed seasoning 24 from the dispenser 20.

As mentioned above, each container 38 as it travels downline on the conveyor 36 and upon approaching the axial station of the curtain-like shower of dispensed seasoning 24 breaks a light beam (or the containers axial position is otherwise sensed or detected). A controller 56 then times the switching ON of the feed belt 68. Given knowledge of the carton 38's length, the controller 56 can simply count the interval of time it takes for the carton 48's trailing wall to reach the given axial station, and then switch the feed roller 72 OFF. Alternatively, the controller 56 can monitor for when the light beam is restored, and then from that event time when to switch the feed roller 72 OFF.

In view of the foregoing, reasonably accurate dosages of seasoning 24 can be reasonably uniformly sprinkled in through the opening of an underpassing open-topped container 38, without much loss by missing the target.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

1. A method of seasoning food product in a mechanized food product line in a process plant therefor, comprising the steps of:
providing a plurality of product containers,
ensuring each container is open at the top,
loading food product into the open-topped container,
serially placing the food-product loaded open-topped containers on a conveyor line, begin a top coating process,
sense and predict by an automatic controller when the front of a carton passes under a vertical plane under which a seasoning dispenser will dispense a curtain-like shower of seasoning mix,
switching the dispenser ON by the automatic controller and begin dispensing,
sense and/or predict by the automatic controller when rear of container passes past the vertical plane,
switching the dispenser OFF by the automatic controller and thus ends the top coating process,
continue serial conveyance of the containers to packaging closure destination.

2. The method of claim 1, wherein:
the step of loading food product into the open-topped container comprises loading a plurality of whole ready-to-roast chickens.

3. The method of claim 2, further comprising the steps of:
continue serial conveyance of closed containers on to refrigeration or freezer storage;
transit in a refrigerated or freezer transit vehicle to grocery stores; and
cook and display the whole chickens in glass-door rotisserie ovens.

4. The method of claim 1, prior to the step of loading food product into the open-topped container, further comprising the steps of:
begin a bottom coating process,
sense and predict by the automatic controller when the front of a carton passes under a vertical plane under which a seasoning dispenser will dispense a curtain-like shower of seasoning mix,
switching the dispenser ON by the automatic controller and begin dispensing,
sense and/or predict by the automatic controller when rear of container passes past the vertical plane,
switching the dispenser OFF by the automatic controller and thus ends the bottom coating process.

5. The method of claim 4, wherein:
the step of loading food product into the open-topped container comprises loading a plurality of whole ready-to-roast chickens; and
further comprising the steps of:
continue serial conveyance of closed containers on to refrigeration or freezer storage;
transit in a refrigerated or freezer transit vehicle to grocery stores;
cook and display the whole chickens in glass-door rotisserie ovens.

6. A method of seasoning food product in a mechanized food product line in a process plant therefor, comprising the steps of:
provide a plurality of rectangular cardboard shipping cartons having left and right sidewalls, a bottom wall, flaps for eventually closing to form a closed top, as well a leading front wall and trailing rear wall,
line the cartons with plastic liner,
dispose the plurality of liner-lined cartons serially on a conveyor,
ensure each carton and liner are open,
convey cartons serially under seasoning dispensing apparatus,
begin a bottom coating process,
sense and predict by an automatic controller when the front of a carton passes under a vertical plane under which a seasoning dispenser will dispense a curtain-like shower of seasoning mix,
promoted alignment of the sidewalls of the underpassing carton to be perpendicular to the vertical plane by spaced side rails,
begin dispensing cycle by the automatic controller starting a seasoning dispensing curtain,
sense and/or predict by the automatic controller when the rear of carton passes past the vertical plane,
end dispensing cycle in consequence thereof by the automatic controller stopping the seasoning dispensing curtain and thus ends the bottom coating process, whereby a measured amount of seasoning mix is dispensed into the underpassing carton and without much loss by missing the target of the open-topped container,
load into each bottom-coated carton a plurality of whole pieces of any of uncooked or under-cooked birds, beef, pork or fish,
begin a top coating process,
sense and predict by an automatic controller when the front of a carton passes under a vertical plane under which a seasoning dispenser will dispense a curtain-like shower of seasoning mix,
promoted alignment of the sidewalls of the underpassing carton to be perpendicular to the vertical plane by spaced side rails,
begin dispensing cycle by the automatic controller starting a seasoning dispensing curtain,
sense and/or predict by the automatic controller when the rear of carton passes past the vertical plane,
end dispensing cycle in consequence thereof by the automatic controller stopping the seasoning dispensing curtain and thus ends the top coating process, whereby a measured amount of seasoning mix is dispensed into the underpassing carton and without much loss by missing the target of the open-topped container.

7. The method of claim 6, further comprising the steps of:
continue serial conveyance of the cartons to a liner sealing station,
seal the liner closed,
continue conveyance of the cartons to a carton closing station, and
close and tape, adhere or staple the flap panels shut.

8. The method of claim 7, wherein the food product comprises whole birds, and said method further comprising the steps of:
continue serial conveyance of closed containers on to refrigeration or freezer storage,
transit in a refrigerated or freezer transit vehicle to grocery stores,
cook and display the whole birds in glass-door rotisserie ovens.

9. The method of claim 6, further comprising the steps of:
providing a first and second conveyor line and a first and second seasoning dispensers,
wherein the steps of disposing the plurality of liner-lined cartons serially on a conveyor and ensuring each carton and liner are open further comprises the steps of:
disposing the plurality of liner-lined cartons serially on the first conveyor, ensuring each carton and liner are open,
pass under the first of seasoning dispenser—bottom coat,
remove off the first conveyor the bottom coated empty open cartons,
load food product in the bottom-coated empty open cartons,
serially place on the second conveyor line,
pass under the second seasoning dispensers—top coat.

10. The method of claim 9, wherein:
continue serial conveyance on to a liner-sealing station,
continue serial conveyance on to a carton-closing station,
continue serial conveyance on to refrigeration storage and/or transit in refrigerated transit vehicle to a remote destination.

11. The method of claim 6, wherein following the end of the bottom coating process, further comprising the steps of:
remove off the conveyor the bottom coated empty open cartons,
load the food product in the bottom-coated empty open cartons,
return to serially placing the food product-loaded, bottom-coated empty open cartons on the conveyor line upline from the seasoning dispenser,
pass under the seasoning dispenser—top coat

12. The method of claim 11, wherein:
continue serial conveyance on to a liner-sealing station,
continue serial conveyance on to a carton-closing station,
continue serial conveyance on to refrigeration storage and/or transit in refrigerated transit vehicle to a remote destination.

13. The method of claim 12, wherein the food product comprises whole birds, and said method further comprising the steps of:
the remote destination comprises a rotisserie oven in any of a grocery store, restaurant, smorgasbord, banquet hall or various sorts of hospitality or food service enterprises whereby workers at the remote destination are relieved of the task of seasoning the whole birds.

14. The method of claim 6, wherein at the end of every dispensing cycle whether it be ultimately proved to be a bottom coating process or bottom coating process, said method further comprising the steps of:
weigh the serially conveyed container after transit past the vertical plane and input the weight of the container to the automatic controller,
pass this container over a lane diverter,
based on weight, divert by the automatic controller controlling the lane diverter bottom coated empty open cartons to a reverse direction conveyor,
load the whole pieces of food product in the bottom-coated empty open cartons while on the reverse direction conveyor,
merge onto the main conveyor upline from the seasoning dispenser the food product-loaded bottom coated shipping cartons on the reverse direction conveyor by the automatic controller controlling another lane diverter,
begin and end the top coat process for the serially conveyed merged container,
weigh the serially conveyed container after transit past the vertical plane and input the weight of the container to the automatic controller,
pass this container over a lane diverter,
based on weight, the automatic controller allowing continuing serial passage of the container on the main conveyor past the one lane diverter.

15. The method of claim 14, wherein the step of merge further comprises the step of:
merge the onto the main conveyor upline from the seasoning dispenser the food product-loaded bottom coated shipping carton on the reverse direction conveyor by the automatic controller controlling the other lane diverter and further sequencing the lane change without colliding with empty open shipping cartons.

16. A method of seasoning food product in a mechanized food product line in a process plant therefor, comprising the steps of:
provide a multiplicity of cutlets of food product,
serially place on a first of two conveyor lines,
pass under a seasoning dispenser top coat,
remove off the top coated cutlets of food product,
provide a plurality of empty styrofoam food package trays,
stack or partially-stack several cutlets in each empty styrofoam food package tray,
serially place on a second of two conveyor lines,
convey to a heat-shrink wrapping station,
wrap cutlet-loaded, top coated styrofoam food package tray in heat shrink film,
shrink film to seal the cutlet-loaded, top coated styrofoam food package, and continue on to refrigeration or freezer storage.
